(19) United States
(12) Patent Application Publication
(10) Pub. No.: US 2004/0158568 A1
(43) Pub. Date: Aug. 12, 2004

(54) Scheduling resources for performing a service

(76) Inventors: Renzo Colle, Rastatt (DE); Stefan Doleschel, St. Davids, PA (US); Franz Hollich, Sinsheim (DE); Dagmar Strumberger, Forst (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/696,498

(22) Filed: Oct. 30, 2003

Related U.S. Application Data
(60) Provisional application No. 60/433,042, filed on Dec. 12, 2002.
(60) Provisional application No. 60/452,383, filed on Mar. 5, 2003.

(51) Int. Cl. G06F 7/00

(52) U.S. Cl. 707/100

(57) ABSTRACT

A computer system and information repository is described for scheduling resources needed to perform service actions. The repository of resource information includes human resource information, reusable resource information, and non-reusable resource information. Each of human resource information, reusable resource information, and non-reusable resource information includes availability information. A scheduling engine associates, based on user input, resource information with task items that need to be completed as part of performing a service action.

### CROSS REFERENCE TO RELATED APPLICATIONS

This application claims priority from U.S. Provisional Application No. 60/433,042, titled “Scheduling Engine” and filed Dec. 12, 2002 and from U.S. Provisional Application No. 60/452,383, titled “Fulfilling Scheduling Orders” and filed Mar. 5, 2003, both of which are incorporated by reference in their entirety.

### TECHNICAL FIELD

This description relates using a computer system for resource planning to perform a service for a customer.

### BACKGROUND

Computer systems can be used to schedule the sequence and timing of work to be performed. Examples of such scheduling systems include a project management system for scheduling the duration and order of tasks to be performed in a project, a manufacturing resource planning system for scheduling resource requirements and manufacturing tasks for an assembly line in a factory, and a resource allocation system for scheduling the deployment of service technicians to a particular field location where service is to be performed. Some computer systems present information and an interface to facilitate a person in scheduling, whereas other computer systems use scheduling algorithms to generate, automatically without human intervention, a schedule. One example of such automated scheduling is a computer system that automatically determines a route for a service technician or sales representative to efficiently provide service to multiple customers where each customer is geographically dispersed from the others.

Computer systems also can be used to schedule resources to be used to perform work. One example of a resource scheduling computer system is a computer system for scheduling people to perform work. In the context of scheduling people to perform work, the people also may be referred to as human resources or labor. In some computer systems, it is possible to schedule people to perform particular work that requires a particular skill, item of equipment, or credential, such as a security clearance or site authorization. The scheduling of the particular person to perform a particular task then is based on a person's specific skills, the equipment available to the person, and the credentials held by the person.

Another example of a computer system used for scheduling resources is a reservation system for scheduling the use of physical locations, such as conference rooms, service bays, or other types of work areas. Yet another type of a resource scheduling computer system is a computer system for managing the availability of supplies, such as spare parts, needed to perform work.

There are many different types of resources, including people, locations, equipment, and supplies, that may need to be scheduled to perform a service. It is desirable in some cases to have scheduling software that is capable of assigning a variety of resource types to perform the service. This may be particularly true when the work to be performed includes many different component tasks, each of which may require different types of resources. A user interface for scheduling software that is able to handle different types of resources and enable a person to schedule different types of resources may be desirable.

The desirability of having scheduling application software capable of handling different types of resources is important from the perspective of an end user who is responsible for scheduling tasks and resources to accomplish a complex service order that involves multiple component tasks that may be performed in different locations, by different people with different skills, and using various types of equipment, service areas, tools, and spare parts. The scheduling task may be further complicated by the existence of contractual constraints (such as planned maintenance agreements and service level agreements) that must be taken into account during the scheduling of service. In scheduling, the ability to view multiple aspects, such as resources and other types of constraints, of the planning situation is desirable.

### SUMMARY

Generally, the invention is an integrated scheduling tool that includes different types of scheduling information, such as people, equipment, work areas, supplies, and spare parts. The scheduling tool provides a comprehensive visual display and user interface such that a user can access and view a wide variety of different types of scheduling information. The scheduling tool enables a user to schedule, based on the accessible scheduling information, a service event that involves different types of resources. The service event can be scheduled based on resources available, including resources of different types. The service event also can be scheduled based on non-resource constraints, such as contractual obligations and customer requirements, such as the availability of the customer or the customer's equipment to be serviced.

One area where the invention may find specific applicability is in the scheduling of service calls by field technicians. This may be particularly useful when service requests are received from customers by a large call center. A date for the service, based on customer requirements and an estimate of the general availability of the necessary resources needed to perform the service, is agreed upon by the customer and the call center representative. The resources needed to perform the service are assigned later by a resource planner who is responsible for scheduling a particular group of resources.

Another area where the invention may find specific applicability is in the scheduling of service performed in a service area or a workshop at the location of the service provider. In some cases, the invention may be particularly relevant when a service provider must schedule a wide variety of resource types within various customer constraints for field service, workshop service, and a combination of both field service and workshop service.

In one general aspect, resources needed to perform service actions are scheduled using a computer system. The computer system includes an engine and a repository of resource information. The engine associates, based on user input, resource information with task items that need to be completed as part of performing a service action. The resource information in the repository is associable with the task items. The repository includes human resource information, reusable resource information, and non-reusable resource information. The human resource information includes availability information for human resources. The reusable resource information includes availability information for reusable resources. The non-reusable resource information includes availability information for non-reusable resources.

Implementations may include one or more of the following features. For example, the repository also may include non-resource constraint information. The engine may associate, based on user input and the non-resource constraint information, resource information with task items. The non-resource constraint information may be provided to the repository of resource information from a computer system other than the computer system for scheduling resources. The availability information for human resources, reusable resources or non-reusable resources may be provided to the repository of resource information from a computer system other than the computer system for scheduling resources.

The non-resource constraint information may include information about contractual requirements. The availability information for human resources may include availability information for individuals or groups of individuals. The availability information for reusable resources may include availability information for tools or availability information for work areas. The availability information for non-reusable resources may include availability information for spare parts.

The task items may include a human resource skill requirement, and the human resource information may include a indication of a skill possessed by particular human resources that are represented in the human resource information. If so, the engine may associate a particular human resource with a particular task item only when the indication of the skill possessed by the particular human resource matches the human resource skill requirement of the task item.

Similarly, the task items may include a tool characteristic, and the reusable resource information may includes an indication of a tool characteristic for particular tools that are represented in the reusable resource information. If so, the engine may associate a particular tool with a particular task item only when the indication of the tool characteristic for a particular tool matches the tool characteristic of the task item.

The engine and the repository of resource information may be capable of communicating using a network with mobile clients. The engine may be configured to send, to each mobile client, resource information associated with task items that need to be completed as part of performing a particular service action. The engine may be configured to receive, from each mobile client, user input for the purpose of associating resource information with a particular task item.

In another general aspect, a data repository includes resource information associable with task items that need to be completed as part of performing a service action. The repository includes human resource information and reusable resource information. The human resource information includes availability information for human resources, and the reusable resource information includes availability information for reusable resources.

Implementations may include one or more of the features noted above and one or more of the following features. The repository also may include non-reusable resource information which may include availability information for non-reusable resources. The repository also may include non-resource constraint information capable of being associated with task items.

Implementations of the techniques discussed above may include a method or process, a system or apparatus, or computer software on a computer-accessible medium. The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system incorporating various aspects of the invention.

FIG. 2 is a flow chart of a process for service order scheduling.

FIG. 3 is a screen snapshot of a user interface showing components of a service order.

FIG. 4 is a block diagram illustrating how the components of a scheduling system are used for monitoring the execution of a service order.

FIGS. 5-8 are examples of user interfaces that may be used schedule resources and monitor the execution of a service order.

FIG. 9 is a block diagram illustrating an execution monitoring process.

FIG. 10 is a block diagram showing how the example user interfaces in FIGS. 7 and 8 may be used to monitor the execution of service orders and change resource assignments for a service order.

FIG. 11 is a screen snapshot of a scheduling user interface.

### DETAILED DESCRIPTION

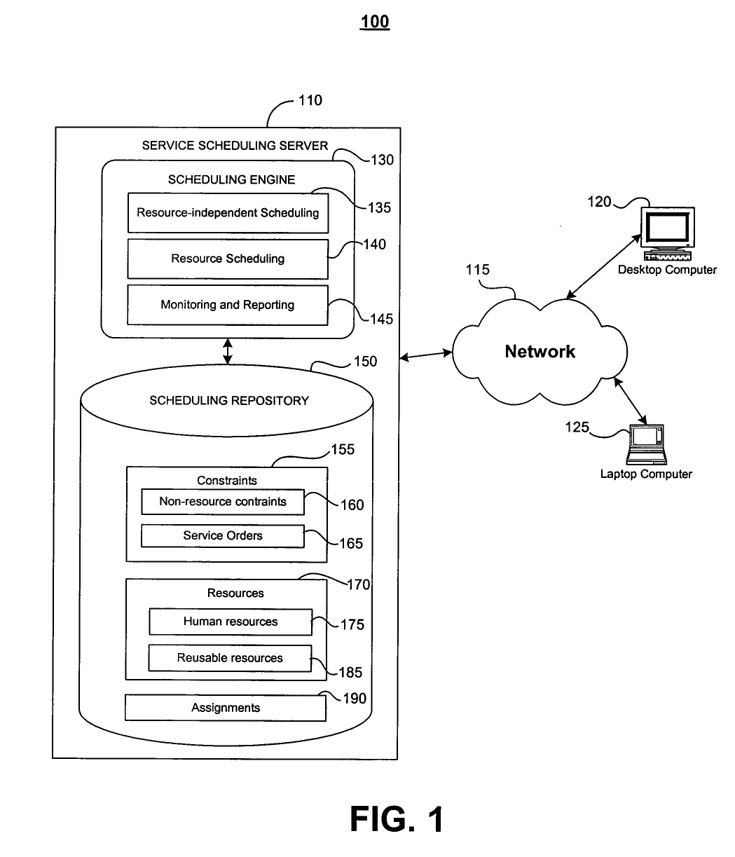

The scheduling system 100, shown in FIG. 1, may be used by a person to schedule different types of resources to provide a service for a customer within specified constraints. Examples of the types of resources that may be scheduled using the system 100 are people (such as service technicians, some of which may have particular identified skills or other types of qualifications), non-reusable resources (such as spare parts), and reusable resources (such as equipment and service areas). The scheduling system 100 includes information about non-resource constraints to be considered when scheduling service. Examples of non-resource constraints include contractual agreements, customer availability, availability of equipment to be serviced, and a date by which the service must be completed.

In the FIG. 1 implementation, the scheduling system 100 includes a service scheduling server 110 connected through a network 115 to a desktop computer 120 and a laptop computer 125. The service scheduling server 110 is a general-purpose computer that includes a scheduling engine 130 that may be accessed by a user of the desktop computer 120 or a user of the laptop computer 125. The scheduling engine includes executable instructions for a resource-independent scheduling function 135, a resource scheduling function 140, and a monitoring and reporting function 145.

The resource-independent scheduling function 135 determines, for a service request, the tasks needed to accomplish the requested service and a service date for the service request. When the service request requires that multiple tasks be performed, the date or dates for each task also may be determined in the resource-independent scheduling function 135. The resource-independent scheduling function 135 for a service request takes into consideration a desired start date or a desired completion date for the service request, tasks to be performed for the service request, a predetermined duration for each task, and a sequence in which the tasks must be performed. The resource-independent scheduling function 135 does not include the assignment of particular resources (such as people, equipment, or supplies) to a service request. In some implementations, however, the general availability of resources needed to perform the service request may be considered during the resource-independent scheduling function 135.

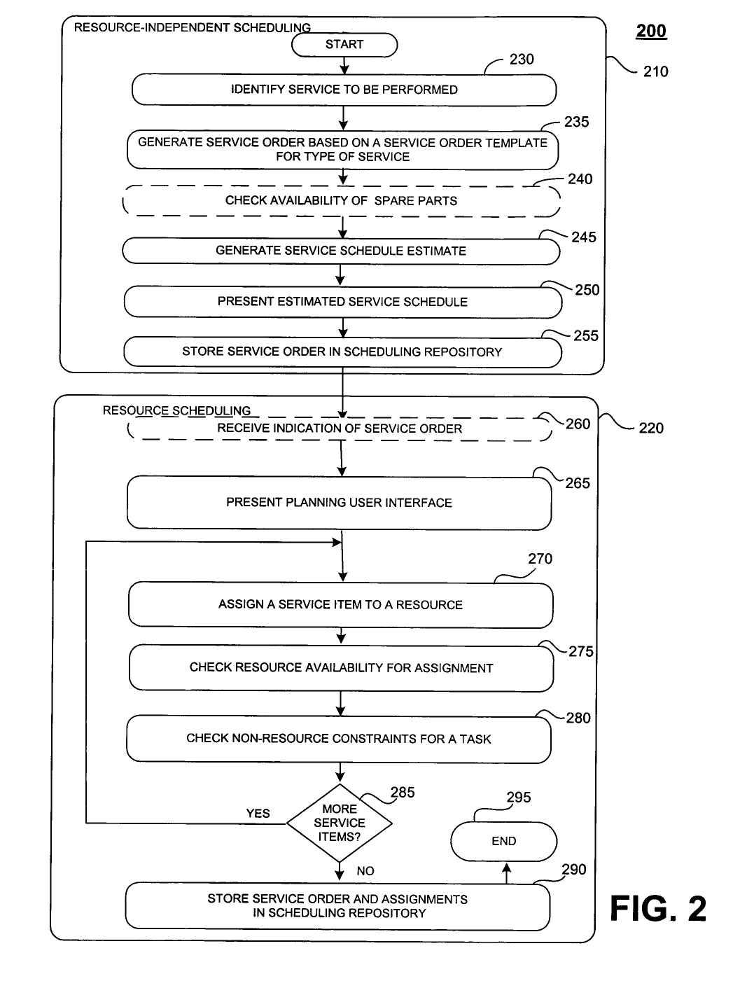

The resource-independent scheduling function 135 may determine, automatically without human intervention, a service date for a particular service request, by using, for example, the method described in FIG. 2. Alternatively, the resource-independent scheduling function 135 may provide a user interface that enables a person to determine a service date for a particular service request. In some implementations, the resource-independent scheduling function 135 may include both automatic scheduling and scheduling by a person using a user interface. For example, in some implementations, the resource-independent scheduling function 135 may automatically generate a date for a service request based on a desired start date for the service request, tasks to be performed for the service request, a predetermined duration for each task, and a sequence in which the tasks must be performed. The resource-independent scheduling function 135 may present on a visual display the automatically generated schedule. A user may modify the resource-independent schedule presented, for example, based on the general availability of resources.

By contrast, the resource scheduling function 140 provides a visual display and user interface that enables a user to assign specific resources to perform the requested service. Resource scheduling also may be referred to as resource-dependent scheduling or resource planning. The resource scheduling function 140 is performed using a visual display and user interface that enables access to different types of scheduling information available in a scheduling repository 150, as described further below and in FIG. 2.

The monitoring and reporting function 145 provides information in the form of interactive alerts, displayed lists, and other types of reports to help a user monitor the execution of the scheduled service requests. The monitoring and reporting function 145 may enable a person to more effectively manage resource utilization and improve customer satisfaction of the service delivery over the use of a conventional scheduling system that does not include different types of resources and constraints.

The scheduling repository 150 is persistent data storage that includes constraints 155 associated with service requests. Constraints 155 include non-resource constraints 160 and service orders 165 that include requests for service.

Information about non-resource constraints 155 may include information about non-reusable resources, such information about spare parts. A spare part may be used by a service technician to replace a defective part of an item of equipment or a machine when service is performed. Information about non-reusable resources may include information about other types of resources that may be used only once and, once used, are no longer available in the performance of another task. Information about non-reusable resources may include whether or not a particular type of spare part (or another type of non-reusable resource) is available and a date when an additional quantity of the spare part is expected. In some implementations, information about non-reusable resources may be included as part of resource information 170 in a scheduling repository.

Constraints 155 also include service orders 165. A service order may be considered a scheduling constraint when the service order includes service to be performed at, or within, a specified time. Examples of non-resource constraints include service-level agreements specified in a particular customer service contract, scheduled maintenance for particular equipment required by contract, and the availability of the customer or the customer's equipment to be serviced. In some cases, the equipment on which service is to be performed is used by a customer to generate revenue. The scheduling of service for such equipment may present more rigid constraints than scheduling service for equipment that is not used to generate revenue.

The scheduling repository 150 also includes data associated with different types of resources 170. A resource may be a person or an object that is used to fulfill a resource requirement for performing a task of a service request. Examples of resources for scheduling are people, work areas, spare parts, and tools needed to perform service.

The resources 170 for which information is included in the scheduling repository 150 include information about human resources 175, and reusable resources 185. Information about human resources 175 includes the identity and other types of information about people who may perform service. Often a person who performs a service is a technician who specializes in the subject matter of a technical area or type of equipment. The particular skills and certification of people performing a service also may be included in human resources 175. When people who perform a service are organized in groups of people, the group may be referred to as a service team. Information about the organization or structure of people also may be included in human resources 175 which allows resource scheduling 140 to be performed for a service team, an individual, or a combination of a service team and individuals.

Information about reusable resources 185 includes information about the availability of tools and other physical resources that are needed to perform a service. When service that requires a particular tool is completed, the tool used in performing the service becomes available for use in performing a subsequent service (as opposed to a spare part that is not available for use in performing a subsequent service). In a broad sense, one type of a tool is a service bay or another type of work area. A service bay includes a place in a service provider's facility where service technicians perform work on equipment. Typically, a service bay is used to perform service on large pieces of equipment, such as an automobile, a truck, a crane, a roller, a bulldozer, a tractor or another type of construction equipment. Examples of types of service bays include a repair bay where repairs to equipment are performed, a washing bay where equipment is washed, and an inspection bay where inspection and, perhaps, small repairs are performed. Information about reusable resources 185 may include information about tools that are provided by different sources. For example, reusable resources 185 may include information about a tool that is rented by the service provider, a tool provided by a customer, a tool held in a central location by the service provider, or a tool that is held by a particular service technician. In some implementations, a particular tool may be associated with a particular service technician in reusable resources 185. Some implementations may categorize tools for which information is included in reusable resources 185. The categorization of tools may be based on, for example, whether the tool is a rented, held centrally, or associated with a service technician.

The service scheduling server 110 is accessible to a user of the desktop computer 120 and a user of the laptop computer 125 through the network 115. The network 115 may be a LAN (“Local Area Network”), a WAN (“Wide Area Network”), or a combination of LANs and WANs.

A user of the desktop computer 120 or the laptop computer 125 uses the scheduling system 100 to schedule resources for a service order. Each of the desktop computer 120 and the laptop computer 125 may be a general-purpose computer that is capable of operating as a client of the scheduling application program or a more special-purpose computer (that is, a device specifically programmed to operate as a client of a scheduling program). Examples of a general-purpose computer include a desktop personal computer, a workstation, or a laptop computer running a scheduling application program. For brevity, FIG. 1 illustrates only a single desktop computer 120 and a single laptop computer 125.

Using the scheduling engine 130 and the scheduling repository 150, a user of the desktop computer 120 or the laptop computer 125 is able to perform scheduling for a particular service request. A user interface is presented by the scheduling engine 130 that permits a user to assign resources of different resource types to a particular service request.

An example of one way in which the service scheduling system 100 may be used is the use of the service scheduling system 100 by an enterprise that provides field service and workshop service for large machines, such as various types of construction equipment. The enterprise may be referred to as a service provider and may have a large number of geographically dispersed workshops. A request for service may be received from a customer by a service representative located in a call center that is geographically dispersed from the workshops. The service representative who receives the call also may be referred to as a service advisor.

The service advisor uses the scheduling system 100 to enter a request for service for the customer. The service request may be referred to as a service order. The service order identifies the particular type of equipment for which service is requested. The scheduling engine 130 uses the resource-independent scheduling 135 function to generate a resource-independent schedule for the service order. The resource-independent schedule generated also may be based on unique customer requirements, such as the date on which the equipment is available to be serviced or a service agreement with the customer. The service advisor works with the customer to determine the date or dates on which the service is to occur.

The service order that includes the service date is stored in service orders 165 of the scheduling repository 150. The service date of the service order is a constraint within which the resource assignments are to be made.

Specific resources then may be assigned to perform the tasks included in the service order. For example, a resource planner who is responsible for a group of resources then uses a user interface generated by the resource scheduling function 140 to assign specific resources of different types, such as people, equipment, work areas, and spare parts, to different tasks (or other aspects) of the service order. Then the scheduling engine 110 checks the service order with the assigned resources against the non-resource constraints 160 that apply to the service order. As described previously, non-resource constraints include contractual obligations and the service end date previously determined through resource-independent scheduling.

The scheduling system 100 may be particularly useful when a combination of field service and workshop service is needed to complete a service order. For example, to service a large piece of construction equipment, a field technician may travel to a customer location to remove a part of the construction equipment for service at the service provider's workshop, a repair of the part may be performed at the service provider's workshop, and a field technician may need to re-install the repaired part in the construction equipment at the customer location. Scheduling such a service request involves scheduling both field service and workshop service, each of which may require the scheduling of different types of resources. Field service may involve scheduling the available field service technician who regularly travels to customer sites (a human resource), a tool (a reusable resource), and a spare part (a non-reusable resource). For example, field service scheduling may involve scheduling the travel of a service technician to the customer location, ensuring spare part availability, and scheduling the transportation of equipment or a resource separately from the travel of a technician (such as when a large spare part that cannot be carried by the technician or in the technician's truck). By contrast, workshop service may involve scheduling bays (such as service bays and washing bays), workshop service technicians to perform the service, centrally-located tools, and spare parts. In some cases, a different resource planner may schedule field service than the resource planner that schedules workshop service.

The ability to separate resource-independent scheduling from resource scheduling for different types of resources may be useful. This may be particularly true when the dates on which service is to occur is agreed upon prior to the assignment of resources to perform the service. For example, the ability to identify a service date before assigning resources may enable a customer service representative to more quickly schedule a service request with a customer than the customer service representative would be able to do if the customer service representative had to first assign resources before rescheduling a service date. The ability to quickly schedule a service date with a customer, in turn, may improve customer satisfaction. In some cases, different types of resources, or different types of services, may be scheduled by different users. In such a case, scheduling a date for a service request with a customer may take a significant amount of time if the service request could only be scheduled after the particular resources are assigned by each different user responsible for a type of resource or service.

The ability to view and schedule different types of resources using the same scheduling software may be useful. This may be particularly true when the same or a similar user interface is used to schedule different types of resources. For example, the ability of a user to view different types of resources to be assigned in the same user interface and schedule the resources using a single scheduling system or within a single user session may be useful. For example, the likelihood of data inconsistencies and mental errors may decrease when a system that enables scheduling different types of resources is used as compared to the data inconsistencies and mental errors that may occur when multiple scheduling systems are used to schedule the service required in a single service order.

The ability to check non-resource constraints when scheduling service also may be useful. For example, the service provider may be contractually obligated to perform particular service on a particular schedule. The resource planner who schedules the assignment of resources may benefit from the ability to view non-resource constraint information, be provided with the results from an automatic check of a proposed schedule against non-resource constraint information, or otherwise take into account non-resource constraints when scheduling a particular service order.

In some implementations, the laptop computer 125 may be a mobile client that functions as an off-line client to the scheduling server 110. A mobile client may use a version of the scheduling engine that receives data from a user of the mobile client and updates data stored on the mobile client. Typically, a mobile client operates a single-user version of the scheduling engine. The mobile client may periodically synchronize the data stored on the mobile client with the data stored at the scheduling repository. A mobile client may use the network 115 to communicate with the scheduling repository during synchronization.

In one example, the laptop computer 125 receives, from the service scheduling server 110, a subset information in the scheduling repository 150 that is appropriate for the user of the laptop computer 125. The user of the laptop computer 125 performs the resource-independent scheduling function 135 and the resource scheduling function 140 using scheduling repository information stored on the laptop computer 125. The resulting assignments and other information that has been updated at the laptop computer 125 is provided to the scheduling repository 150 during synchronization. Alternatively, the laptop computer 125 sends, to the service scheduling server 110, user input for the purpose of associating resource information with a particular task item in a service order.

In some implementations, a personal digital assistant (PDA) may be used to access the scheduling server 110. The PDA may have a smaller capacity to display and store data as compared with the desktop computer 120 or the laptop computer 125. In such a case, the PDA may be able to only display assignments for a particular user or a particular user group and provide to the scheduling server 110 information regarding whether an assignment was been accepted and/or completed. For example, a task may be sent to a particular service technician's PDA that is a mobile client for the scheduling server 110. The service technician displays the task on the PDA and indicates whether the service technician is able to work on the task. The indication is sent to the scheduling server 110 from the PDA. The service technician later uses the PDA to enter and send information to the scheduling server 110 about work on the task. Such information may include, for example, the amount of time spent on the task, the spare parts used on the task, and whether the task is completed.

Referring to FIG. 2, a process 200 for service order entry and scheduling may be performed by a processor executing instructions from the scheduling engine 130 using data from the scheduling repository 150, both in FIG. 1. The context for this example is an enterprise that offers multiple types of services for different types of machines, as described previously, in which a service advisor in a call center performs resource-independent scheduling 210, and a resource planner responsible for a group of resources performs resource scheduling 220. In some implementations, the functions performed by the service advisor and the resource planner may be performed by the same person.

When resource-independent scheduling 210 is initiated, the process 200 controls a processor to display a user interface that allows a user of the scheduling engine 130 to perform service order entry and scheduling. The processor presents a user interface that allows a user to identify a service to be performed (step 230). The service to be performed may be identified by the type of equipment being serviced (such as the identification of the manufacturer, the model, and the general type of equipment), the type of service requested (such as a routine maintenance check or a repair of a particular part), and the customer for whom the repair is being performed. To do so, the processor may display one or more prompts or lists from which a user makes a selection. For example, the processor may present a list of equipment and the types of service that may be performed for each type of equipment. The user may then identify the service to be performed by using the user interface to make a selection or selections. Alternatively, the processor may present a user interface for identifying a customer. In response to the identification of a particular customer, the processor may present a list of equipment owned by the customer and a list of the types of service that may be performed for each type of equipment. The user then selects the appropriate equipment and type of service.

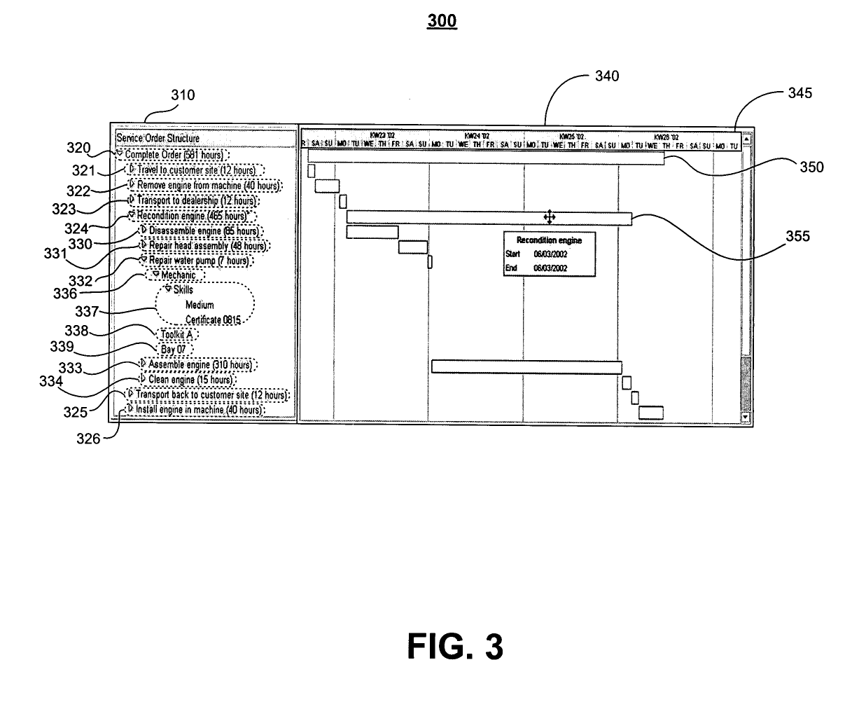

Based on the service identified, the processor generates a service order (step 235). To do so, the processor creates a service order based on a generic service order template for the service requested. The generic service order template is a collection of reusable data that identifies each of the tasks to be performed for a particular type of service and, for each task, a predetermined, expected duration of the task and an identification of other tasks on which the task depends. The tasks in the service order are shown on the user interface as being organized in hierarchy, as illustrated by FIG. 3.

Referring also to FIG. 3, a user interface 300 is divided into two major panels, including a display of a task list 310 for a service order on the left side and a graphical depiction 340 of the tasks and their interrelationships on the right side. The task list 310 displays a hierarchical ordering of tasks, illustrating the dependencies between tasks within the service order. The ability to organize tasks into a hierarchy of dependencies may be particularly useful for service orders that have a large number of tasks.

The task list 310 includes a service order header 320 that identifies the service order by a title and the total duration required to perform the service (here, “581 hours”). The task list 310 also includes first-level tasks 321-326. First-level tasks are the top-level tasks in the hierarchy of tasks in the service order. A first-level task may have sub-tasks, each of which may be referred to as a second-level task. A first-level task cannot be a sub-task of another task. The task list 310 lists each of the first-level tasks 321, 322, 323, 324, 325, or 326 in sequential order such that a subsequent task is only performed after the task's immediate predecessor has been completed. For example, task 322 begins only after task 321 is completed, task 323 begins only after task 322 is completed, and so on. Each task in the task list 310, such as tasks 321-326, includes a duration of a number of hours, as shown in parentheses in the task description for each task. First-level task 324 includes second-level tasks 330-334 that are performed in order to complete the first-level task 324. Although the task list 310 shown in service order only includes two levels of tasks, additional hierarchical levels of tasks may be included in a service order. (Additional aspects of the service order will be described later.) Each of the tasks in the task list 310, such as tasks 321-326, may be referred to as a task item.

The second-level task 332 shows resources required to perform the task 332. The task 332 identifies that a human resource 337 with mechanic skills, a re-usable resource 338 of a particular type of toolkit (here, “Toolkit A”), and a work area 339 (here, a “Bay”) are required to perform the task 332. The required human resource 337 is more specifically identified as needing mechanic skills of a particular level (here, “Medium”) and a particular certification (here, “Certificate 0815”).

Referring again to FIG. 2, the processor may check the availability of a spare part required in the service order (step 240). To do so, the processor may determine whether a required spare part is in the inventory of the service provider. For example, the processor may access non-reusable resource 180 information in the scheduling repository 150 in FIG. 1. In some implementations, the processor may query an external system, such as an inventory management system, a supply chain management system, or another type of logistics system, to determine whether a required spare part is available and, if not, a date on which the spare part is to be available.

The processor then generates a service schedule estimate that includes a planned start date and a planned end date for each task in the service order (step 245). The service schedule may be estimated based on the date on which the service is to begin.

This date may be referred to as the service planned start date, and the process of scheduling based on the service planned start date may be referred to as forward scheduling.

When the processor has checked on the availability of a spare part (step 240), the availability of the spare part (or the estimated date on which the spare part will be available) is taken into account in generating a service schedule estimate. Considering the availability of a needed spare part before scheduling service may help improve customer satisfaction. For example, a delay in service due to waiting for a spare part may be reduced or avoided. The ability to schedule service based on spare part availability may be particularly important when an expensive or cumbersome spare part is required for the service because expensive or cumbersome spare parts may be less likely to be available.

As is conventional, the processor determines an estimated start date and an estimated end date for each task in the service order based on the service planned start date, the duration of the task, and any task sequence dependencies identified between tasks. In some implementations, each task may be identified with an additional scheduling constraint of either “as soon as possible” or “as late as possible.” If so, the processor then takes into account the additional scheduling constraint.

In some implementations, rather than estimating the service schedule based on the planned start date, the processor may automatically estimate the service schedule based on a date by which the service is to end. This date may be referred to as the service planned end date, and the process of scheduling based on the service planned end date may be referred to as backward scheduling. In some implementations, a system administrator or another type of user may determine whether to use backward scheduling or forward scheduling when determining a task date.

The processor then displays the estimated service schedule on a user interface (step 250). The display, for example, may be the service order display 300 illustrated in FIG. 3. The service order display 300 includes the task list 310 that identifies a hierarchical structure of tasks 320-333 and a schedule 340 for the performance of each task. The schedule 340 includes a date indicator 345 that identifies particular days and horizontal time bars, such as time bars 350 and 355. The time bar 350 corresponds to the dates on which the service order is to be performed, whereas the time bar 355 corresponds to the dates on which the task 324 is to be performed. Thus, the display 300 of the service order provides an interface in which a user may display the components of the service order and the schedule that corresponds to each service order component.

In some implementations, the time bar 350 may display hours and portions of an hour (such as a quarter of an hour) and the duration of a task and an assignment may be based on a portion of an hour. The granularity of time assigned may be based on the context in which the scheduling is performed. Some implementations may allow a user to determine the granularity of the duration unit assigned. For example, some service orders may use a portion of a day as a measure of duration length, whereas another service order may use a portion of an hour as a measure of duration length.

In some implementations, the processor may display a user interface that allows a user to modify the estimated dates of the service items or the service planned start date or the service planned end date. Additionally or alternatively, the processor may present information on the general availability of resources that may be used in the service. For example, a calendar of valid working days and working hours per day for a scheduling entity (such as a workshop, a store or a service technician) may be presented. A general workload for the scheduling entity also may be presented. For example, when a majority of the resources are scheduled, the display may so indicate. This may provide the user with general knowledge about the ability of the resources to take on more work. Using such general knowledge, the user may modify the estimated service schedule accordingly. This may help increase the accuracy of the resource-independent scheduling.

The processor then stores the service order in the scheduling repository 150 (step 255). Subsequently, the service order may be accessed from the scheduling repository 150 for use in the resource scheduling sub-process 220, reporting functions, or monitoring functions.

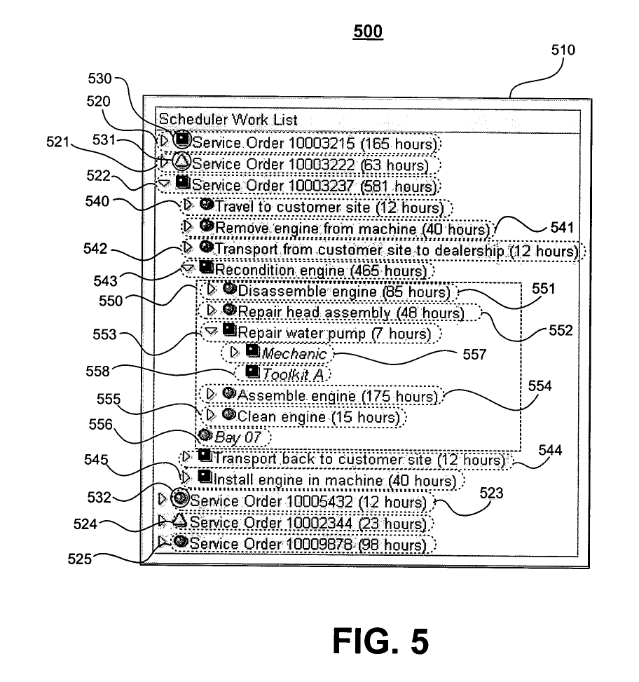

After the resource-independent scheduling sub-process 210 is completed, the resource scheduling sub-process 220 begins. The sub-process 220 may begin when the processor receives an indication of a particular service order (step 260). This may occur, for example, when a service order created in the sub-process 220 is displayed on a list of service orders, such as described below in FIG. 5, and a user selects the service order from the list of service orders, as may occur when the sub-processes 210 and 220 are performed by different users or are performed in a different scheduling sessions. When the sub-processes 210 and 220 are performed by the same user in a single session, an indication of the service order may not necessarily be received.

The processor presents a planning user interface that displays a service order and different types of resources that are available to be scheduled (step 265). The user is able to create, change or delete assignments for the displayed resources using the same or very similar process for each type of resource. The processor also presents resource availability information, including human resources and reusable physical resources, such as tools, vehicles and service work areas (also step 265). Using the planning user interface, the user is able to plan the use of multiple resources of various resource types perform the service items for the service order. The planning user interface may be referred to as a planning board. Examples of resource types included in the planning user interface include human resources and reusable resources. Some implementations also may include resources having a non-reusable resource type (such as a spare part) in the planning user interface.

The resource planner is able to schedule service items in the service order using the planning user interface. The resource planner is able to view the resource requirements of each service item and resources that are available to perform the service item. The resources may be of different types, human resources, reusable physical resources, such as tools, vehicles, work areas and other types of equipment, and non-reusable physical resources, such as spare parts. The resource planner is able to use the user interface presented by the scheduling processor to assign a service item to one or more resources. This may be accomplished by clicking or otherwise selecting a service item and dragging the selected service item to a particular resource representation (such as an icon) for a particular date and time period.

The planning user interface includes the resources for which the resource planner user is responsible. The resources may be a group of resources, such as a group of field technicians, a particular service region served by a group of field technicians, a workshop, or a team within a workshop. The scheduler is able to view different resources available to the schedule, including particular technicians, particular bays, particular tools, or particular mobile tools taken from a centralized pool of mobile tools.

In some implementations, the same planning user interface may be used by resource planners who are responsible for scheduling field service and different resource planners who are responsible for scheduling workshop service. This may be useful, particularly when a service provider provides both field service and workshop service options. The ability for the same planning user interface to be used for field service and workshop service may be even more useful when a single service order includes some service items that relate to field service and other service items that relate to workshop service. This is important as a resource planner that schedules field service is responsible for scheduling technicians, tools, transportation, spare parts (but not bays or centralized tools), whereas a resource planner that schedules workshop service is responsible for scheduling work areas, centralized tools, spare parts, and workshop technicians. The resource planner uses the same interface for scheduling field service and workshop service. In some implementations, the planning user interface may present different views as appropriate for the resources for which the particular scheduler is responsible.

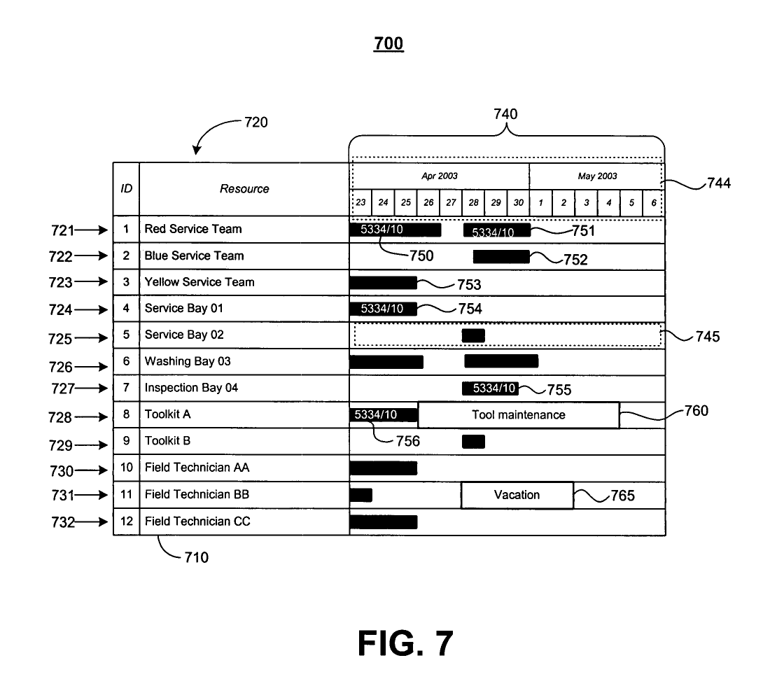

In one example, the planning user interface may present resources as a vertical list and present a horizontal time line. A line or bar indicating non-availability of the resource may be displayed to the right of the resource and corresponds to the portion of the time line during which the resource is not available. For a technician, or another type of human resource, availability is determined based on assignments and the technician's work schedule, vacation time, and sick time. Tools are scheduled by assignment and other types of availability constraints. Examples of other types of availability constraints include maintenance, repair or rental of the tool to another party. Using the planning board user interface, the resource planner may create a new assignment for a resource by identifying a resource, a task and a particular date and, optionally time. An example of a such planning user interface is shown in FIG. 7.

Based on the user's interaction with the planning user interface, the processor receives an assignment of a task to a resource (step 270) and checks for resource availability for the assignment (step 275). An assignment associates a resource with a task to be performed at a particular date, and optionally time. In some implementations, the processor may check the availability of the assigned resource for the particular date and optional time period indicated and only allow resource to be assigned when the selected resource is available at the desired date and time. By contrast, some implementations may permit the assignment of a resource even when the resource is assigned to another task or otherwise not available at the desired date and time. This may be referred to as “overbooking” a resource. The ability to create assignments even when a resource is previously assigned may be useful, particularly when a human resource is involved and change to the person's work schedule may be made (for example, a person may be asked to work overtime to accomplish the work).

A human resource assignment may be made for a particular individual or particular individuals, a group of people (such as a service team or an organizational division), or a combination of individuals or groups. In some implementations, particular skill sets or credentials of technicians may be taken into account during the assignment of resources. Similarly, a work area assigned may be a specific work area (such as a particular service bay) or may be a service location (such as the service center in a particular location).

The user interface may permit multiple resource assignments to be made to the task, and different types of resources may be assigned. For example, a service item may require two service technicians, particular tools, and a service bay in which to work and an assignment of each resource may be made for the service item.

After resources are assigned to the service item, the processor checks for non-resource constraints that relate to the task (step 280). For example, the processor may determine whether the customer for which the service is being performed has a service level agreement or other type of contract that constrains or otherwise affects the task. Another example of a non-resource constraint is availability of the customer machine to be serviced. By checking for non-resource constraints, scheduling conflicts and errors may be reduced.

The user may continue to use the planning user interface to assign resources to tasks (step 270), check resource availability (step 275), and check non-resource constraints (step 280) as long as the user desires, as illustrated by step 285. The processor then stores the service order and assignments in the scheduling repository (step 290) and the process 200 ends (step 295). In some implementations, the processor may only store a service order that has changed and assignments, and the processor may not store a service order that has not changed.

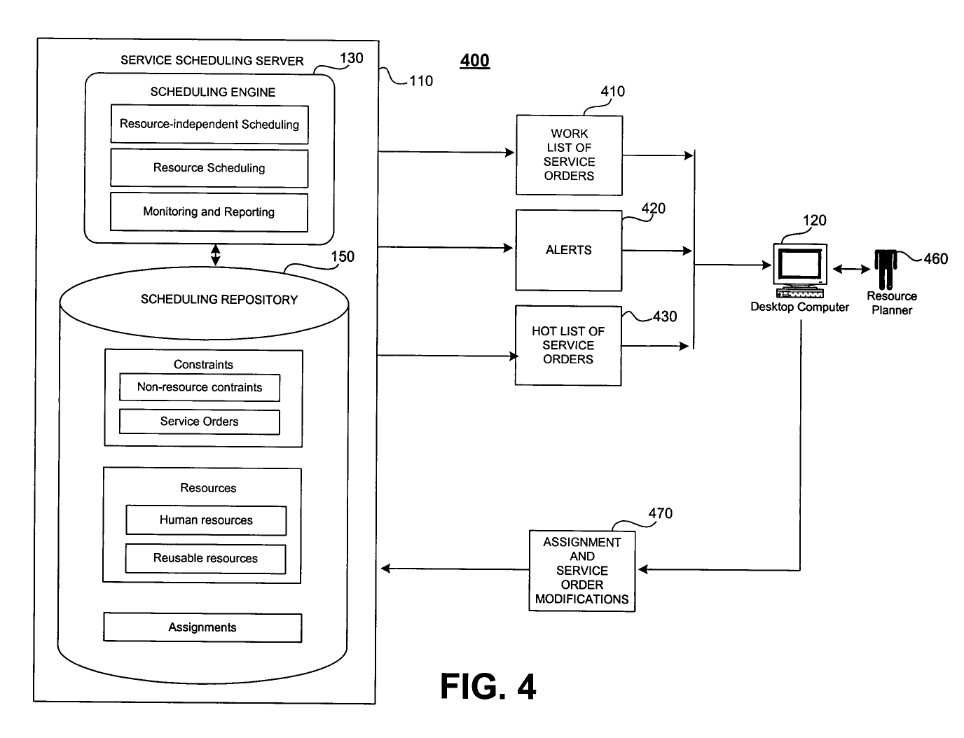

FIG. 4 illustrates the use of the scheduling engine 130 and the scheduling repository 150, both described previously in FIG. 1, for service schedule monitoring. To manage and control resources, assignments and service order progress, different types of reports and monitoring capabilities are provided by the scheduling server 110. The scheduling engine 130 and the scheduling repository 150 produce a work list of service orders 410, alerts 420, and a hot list of service orders 430 that are accessible to a resource planner 460 using the desktop computer 120, described previously in FIG. 1. The resource planner 460 uses a user interface for monitoring the service schedules in the scheduling repository 150. The monitoring user interface may enable a resource planner to more effectively monitor the execution of service orders, which may, in turn, result in improved customer satisfaction. The monitoring user interface also may help a resource planner to more effectively monitor resource utilization, which may enhance the revenue generation or profitability of the service provider enterprise. The more effective use of resources also may improve customer satisfaction.

The work list of service orders 410 includes a list of service orders that are associated with a particular resource planner or a group of resource planners. The work list may be a hierarchical ordering of service orders that illustrate dependencies of tasks within a service order, as described previously in FIG. 3.

The alerts 420 include interactive messages or another type of alerts that presents information relevant to a particular resource planner or group of resource planners. An alert may present a warning about the overbooking of a resource, a non-resource constraint violation, or a scheduling change. An example of a scheduling change includes a change in the planning end date (or planning start date) of a service order based on a customer's request, or a change based on a date change in a task, such as may occur when a spare part arrives later than scheduled or a previous task on which another task depends occurs later the date for which the task was scheduled.

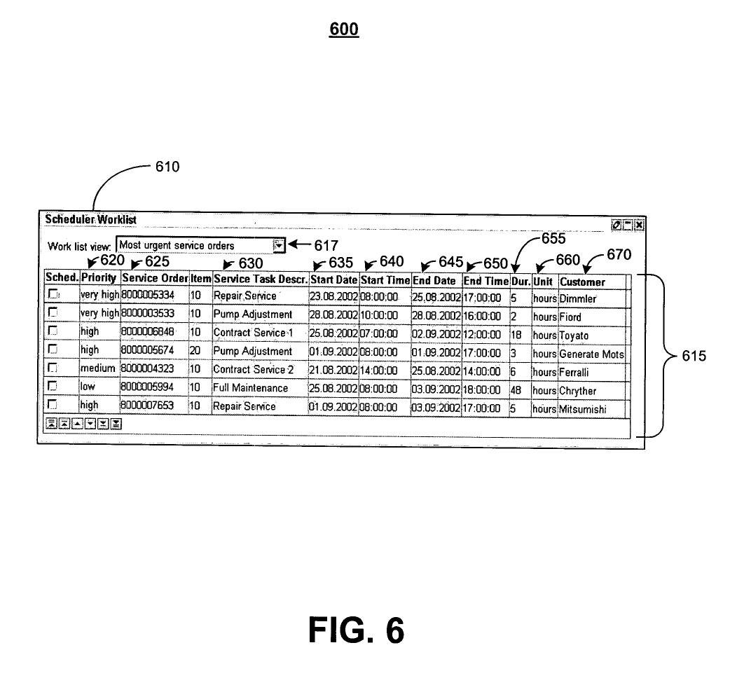

A hot list of service orders 430 includes a list of service orders that requires attention by the resource planner in the near future. The criteria used to generate the service orders to be displayed by the hot list 430 may be selected, defined or otherwise configured by the resource planner, as described further in FIG. 6.

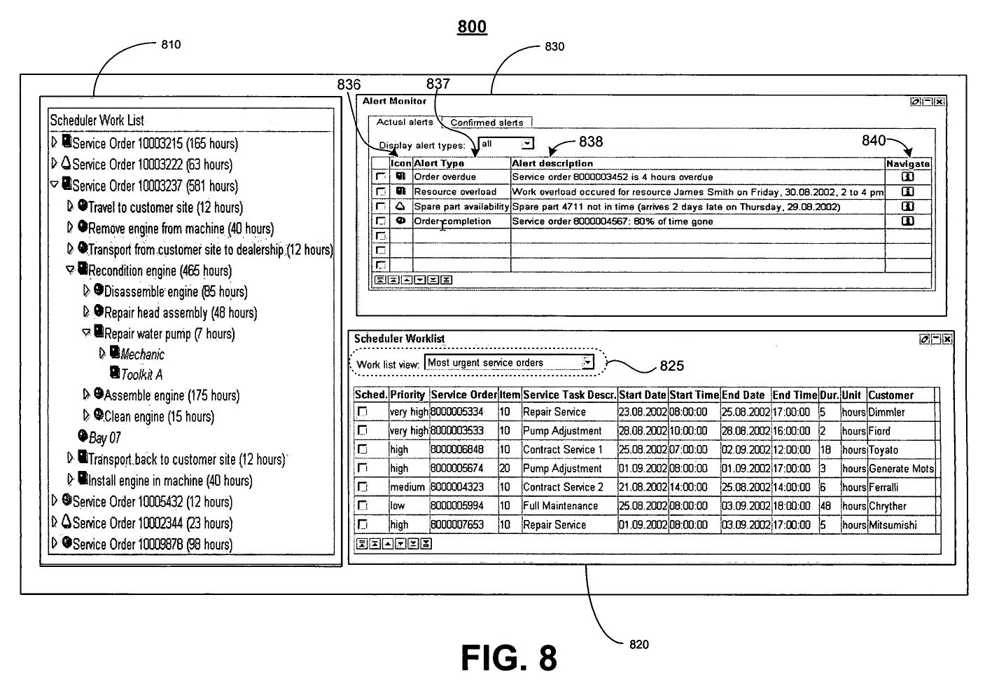

The resource planner 460 may use a planning user interface (such as the planning user interface 800 described in FIG. 8) to identify assignment and service order modifications 470 for a service order based on information from the work list of service orders 410, the alerts 420, or the hot list of service orders 430.

Referring to FIG. 5, an example of a user interface that is displayed to a user who is scheduling resources or otherwise planning the execution of work for service orders will now be discussed in detail. FIG. 5 shows a screen snapshot 500 of such a user interface, which presents a list of service orders for which the user is responsible within a time frame. The time frame for which service orders are presented can be configured by the user. For example, a user may chose to have presented, in the user interface, all service orders that have tasks that are scheduled to occur within two weeks, or all service orders that have tasks to be completed within the next two days. The list of service orders also may be generated based on the organizational membership of the user—that is, the service team or another type of organizational component to which the user is associated. This may be beneficial in a team environment in which service orders are assigned to locations or teams, rather than being assigned to a particular individual.

The work list 510 is presented in a hierarchical (or tree) structure with a service order being the top level of the hierarchy. Service orders 520-525 are illustrated. Each service order is identified by a service order identifier. In addition, the duration for each service order is displayed, as is a planning status for each service order. In this implementation, a symbol is presented to indicate a planning status for each service order with a square indicating that the resources are already planned resources (as illustrated by planning symbol 530 for the service order 520), a triangle indicating that the resources are not planned (as illustrated by planning symbol 531 for the service order 521); and a circle indicating that some of the resources required by the service order are partially planned (as illustrated by planning symbol 532 of the service order 523). Other symbols may be used.

A user is able to display successive levels of each service order (or drill down) to view tasks and resources applicable to a particular service order. After displaying a successive level, the user may hide or collapse the level. In this example, the tasks 540-545 of service order 522 are displayed. Like a service order, each task includes the duration of the task and a planning symbol to indicate the degree to which resources have been assigned. Successive levels 550 of the task 543 are displayed. The successive levels 550 including additional tasks 551-555 and a resource 556 (“Bay 07”) assigned to task 543. The task 553 has been assigned a human resource 557 (“Mechanic”) and a reusable resource 558 (“Toolkit A”). The work list 510 presents a task in the context of other tasks in a particular service order.

The planning symbols allow a user to determine whether additional planning is required for a service order or task without drilling down into the service order or task. This may help improve the efficiency with which service planning is performed.

In some implementations, a user may be able to select a different one of several predefined views of the work list. Each view of the work list includes a filter criteria to identity the service orders that are to be listed on the work list 510 and a display criteria to identity the types of information to display for each service order, task or resource displayed on the work list 510.

In some implementations, a hot list of service orders may be presented in addition to or in lieu of the work list 510. FIG. 6 shows a screen snapshot 600 of such a user interface, which presents a hot list of tasks 610 which the user desires to monitor. In contrast with the hierarchical list of service orders in the work list 510 in FIG. 5, the hot list 610 is a flat (non-hierarchical) list of tasks 615. A task is not presented in context of the other tasks in a work order, as a task is presented in work list 610. The tasks 615 listed apply to various service orders. Tasks are selected for presentation on the hot list based on one of several criteria. Here, the tasks are presented based on the most urgent service orders 617. Other examples of criteria for the hot list 610 include all open service orders for a single customer, all service orders that require a special tool or a particular bay, or all open service orders for a particular type of equipment.

For each task in the hot list 610, a priority 620 is displayed. The priority 620 may be a static priority assigned to the service order or a task within the service order that remains with the service order or the task regardless of when the due date of the task or the service order. For example, the scheduling system or a user may assign a static priority of “urgent” to a service order based on customer status. The priority 620 also may be a dynamic priority that is determined by the system based on the due date of the task or the service order. The priority of a task may be changed by the scheduling system automatically without human intervention as time passes and the due date approaches. In some implementations, a combination of static priority and dynamic priority may be used. For example, a priority for a particular task may be derived based on an importance factor associated with the customer for whom the service is being performed and based on the due date of the task or service order.

For each task in the hot list, the following information is displayed: the service order number 625 of the service order to which the task applies, the task description 630, the start date 635, the start time 640, the end date 645, the end time 650, the duration 655, the duration units 660 (such as hours, days, or weeks), and the customer name for which service is being performed.

A user can assign a task to a resource by selecting an an item in the work list 510 or a task in the hot list 610 and dragging the selected item or the selected task to the planning board for the assignment of resources to the service order, as described below.

Referring to FIG. 7, an example of a user interface that is displayed to a user who is scheduling resources or otherwise planning the execution of work for service orders will now be discussed in detail. The planning user interface also may be referred to a planning board. The planning board 700 consists of a chart 710 identifying the resources 720 for which the user is responsible. Each resource is represented by a row 721-732. Different types of resources are presented in the planning board 700. More specifically, human resources 721-723 and 730-732, work areas 724-727, and tools 728-729 are shown. In some implementations, different resource types may be shown on the planning board using different colors and/or descriptive text such that the different resource types may be distinguishable from one another.

In some implementations, a user temporarily can remove a single resource or a group of resources from the planning board for better visibility of the remaining resources. Additionally or alternatively, a hierarchical group of resources may be presented, and, if presented, may be expanded and collapsed such that individual resources may be displayed or hidden. For example, the red service team 721 may be expanded to show the individuals that are associated with the red service team 721 (not shown in FIG. 7).

The planning board 700 displays a date range 740 (here, Apr. 23, 2003 to May 6, 2003). Each displayed resource includes a corresponding time bar. For example, the service bay resource 725 includes time bar 740 that corresponds to the time period 744.

An assignment for a resource is indicated by a horizontal assignment bar displayed within the time bar for the resource. For example, assignment bars 750 and 751 are indicated for the red service team resource 721; assignment bar 753 is indicated for the blue service team resource 722; and assignment bar 723 is indicated for the yellow service team resource 723. The duration of the assignment is indicated by the length of the horizontal time bar.

The planning user interface also indicates scheduled tool maintenance time 760 when the toolkit resource 728 is not available. Similarly, the planning user interface indicates vacation time 765 for the field technician 731 when the field technician is not available.

In some implementations, the work schedule of a human resource (that is, the days and times that the person customarily works or is scheduled to work) may be shown to indicate when the person is available for assignments. An assignment may be made to a resource that is not associated with a task or service order. Such an assignment may be referred to as a manual assignment. Manual assignments, for example, may include an assignment to attend a training course. The ability to include assignments that are not associated with a service order helps increase the comprehensiveness of the information displayed by the planning user interface, and so may increase the accuracy of the planning performed using the planning user interface.

Colors may be used in the planning user interface to convey information about an assignment such as the priority of an assignment and/or the status of an assignment (such as assigned, informed, accepted, rejected, released, at customer site, or confirmed). The use of color to convey information may increase the ability of the user to accurately and quickly perceive the planning situation. Some implementations may use different patterns, in addition to or in lieu of color, to convey assignment information.

Actual schedule data may be displayed when such information is available for a resource. For example, actual schedule data may be shown as a second time bar adjacent to the planned assignment bar for the resource. This may enable the resource planner to compare planned and actual utilization of the resources and discover deviations between planned and actual resource utilization.

In some cases, actual schedule data may be available from a work reporting system in which a service technician reports in real-time the task on which the service technician is working. The information generated by such a system may be referred to as “clock on/clock off” information because a service technician may be said to “clock on” a task or service order (collectively, service item) when the service technician starts to work on the service item and “clock off” a service item when the service technician has finished working on the service item. A user may be able to note that the service technician is no longer working on the service item even if the service item has not yet been completed. An indication that the service technician has “clocked off” a service item may only indicate that the service technician is not actively working on the service item and may not indicate that the service item has been completed. The ability of a service technician to record time to a service item, rather than an assignment, may be useful because the service technician is able to perform work without being explicitly assigned the task in the scheduling system. In addition, the ability of a technician to clock on to a service item or a service order without being assigned to it in the scheduling system allows for execution deviations from the planning situation which may occur independently of the scheduling system. The ability of a scheduling interface to present actual schedule data, close to the time in which the service occurs, may be useful. By viewing the clock on/clock off visualization on the planning board the scheduler is informed about these deviations and can adapt the planning situation by changing assignments as necessary.

In some implementations, the planning user interface also may include the current geographical coordinates of a resource, which such coordinates are provided by a geographical positioning system. This may be particularly useful in using the planning user interface for field service. The interface for resource data can be used to update the actual geographical coordinates.

Dependencies between assignments also may be shown on the planning user interface (such as by connecting lines between service items). The dependencies between assignments may be based, for example, on the structure of tasks in the service order.

Non-resource constraints may be displayed in the planning user interface. Examples of such non-resource constraints include constraints from a service contract or a service level agreement. In some implementations, a user may optionally be able to display all non-resource constraints associated with a service order.

A user uses the planning interface to create an assignment for a resource. This may be accomplished by using a pointing device to select a task from a service order, such as a service order displayed in the work list 510 or the hot list 610 and “dragging” the task to a time bar of the resource to be assigned to the task. The scheduling engine displaying the planning interface determines whether the type of resource selected matches a resource type associated with the task. This may be accomplished, for example, based on a tool identifier (such as a material number) for a tool. In the case of human resources, the required qualifications are compared with the actual skills of the selected resource. This may be referred to as skill matching. Whenever a resource does not fit the requirements of the task, an alert is generated and displayed, for example, in an alert monitor, described later in FIG. 8. The default duration of the assignment is determined based on the duration of the task. The default duration of the assignment may be modified by the user.

When the planned duration of the task exceeds the working hours of a human resource, the scheduling engine displays a message in the planning interface. The user may chose whether overtime is used to complete the assignment, the assignment is to be carried over to the next working day for the same human resource, or carried over to the next shift or next working day for a different human resource.

In some implementations, a temporary connection between a tool and a technician may be created. For example, the resource planner may selecting two resources on the planning user interface and identity the time period during which the connection is to persist. For the duration of this temporary connection, the resources only may be scheduled together. This may be useful to indicate that particular resources (such as a tool) is reserved for a field service technician for the duration of a trip, which may be include multiple individual assignments.

In some implementations, a user is permitted to change the availability of a resource manually without reference to a service order item. This may be useful to update scheduling information when a tool malfunctions or a technician becomes ill.

FIG. 8 is an example of a monitoring user interface 800 that includes a work list 810, a hot list 820, and an alert monitor 830. The monitoring user interface 800 also may be referred to as a scheduler workplace or a resource planner workplace. The work list 810 is a hierarchical view of service orders a service scheduler is responsible for, in general depending on the service group (field service or work shop) and a time frame, as described previously with respect to FIG. 5.

The hot list 820 is a non-hierarchical (or flat) list with different views of open service order items for which the resource planner is responsible, as described previously in FIG. 6. In some cases, the hot list 820 may be a filtered view of the complete work list 810. The records shown in the hot list 820 are filtered based on the criteria identified in 835.

The alert monitor 830 is a window of the monitoring using interface 800. The alert monitor 820 displays a list of alerts 835. Each alert in the list 835 includes a symbol indicating the seriousness of the alert 836, an alert type 837, and an alert description 838. An alert may be associated with a service order, a task, a resource, or an assignment. The resource planner may navigate directly from an alert in the list 835 to the corresponding item (that is, the service order, task, resource or assignment) by selecting one of the navigate buttons 840 that corresponds to the particular alert.

The conditions that cause the generation of an alert may be configured by a user or programmatically configured. For example, the generation of an alert for an overdue task may be predetermined. In some cases, an alert for an overdue tasks may generated thirty minutes after the planned end of a task, whereas in another implementation an alert for an overdue task may be generated only several hours after the planned end of a task. Similarly, an alert for a resource overload may be generated in one implementation only when the utilization of a resource exceeds 100%, whereas in another implementation an alert may be generated when utilization exceeds 80%.

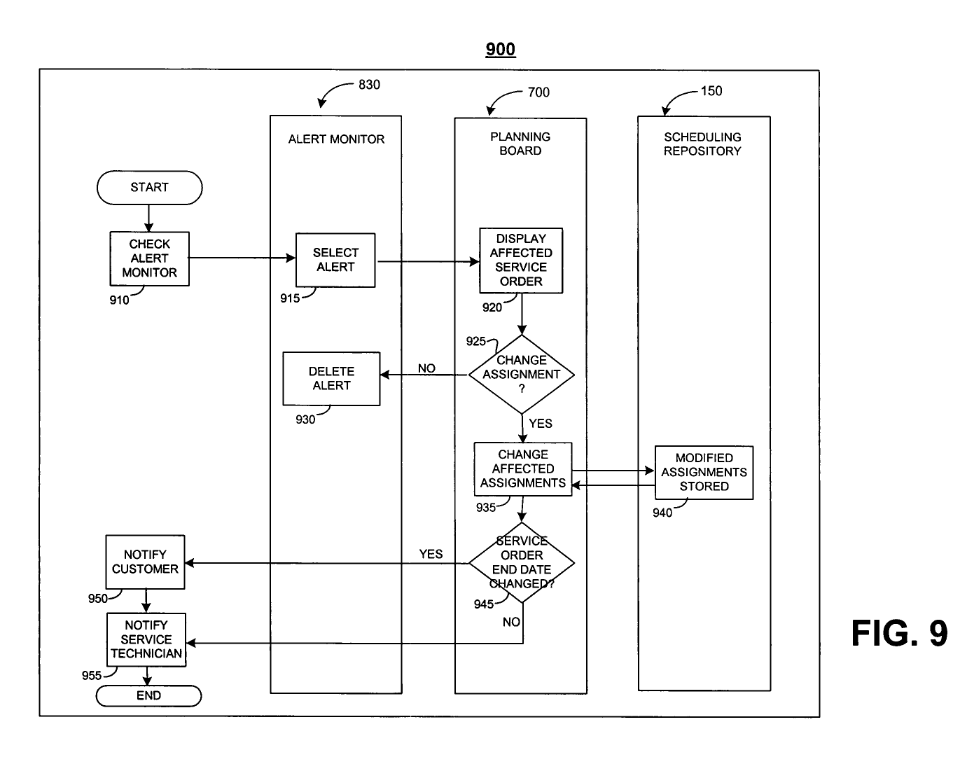

Referring to FIG. 9, the monitoring user interface 800 may be used to monitor the execution of service orders using an execution monitoring process 900. A resource planner user may use the monitoring user interface 800, for example, to check the progress of a particular service order, review service order processing for a resource or group of resources in general, or review resource utilization.

For example, a resource planner may start by checking the alert monitor 830 of the monitoring user interface 800 in FIG. 8 (step 910). The resource planner may select a particular alert in the list of alerts 838 (step 915) and, using the corresponding button of the navigate buttons 840, display the corresponding task in the planning board 700 in FIG. 7 (step 920). The resource planner, using the planning board 700, is able to view the assignment of the tasks in the service order to various resources and determine whether an assignment needs to be changed (step 925). When the resource planner determines that an assignment does not need to be changed (step 925), the resource planner deletes the alert (step 930). In some implementations, the resource planner may not be permitted to directly delete the alert but, instead, may confirm that no action is required by the alert. The use of a confirmation procedure rather than a immediately deleting the alert may be preferable when a record (such as an audit trail) of how alerts are handled is desirable.

When the resource planner determines that an assignment needs to be changed (step 925), the resource planner uses the planning user interface 700 to modify the assignment, such as by assigning a different resource or an additional resource to the task (step 935). The scheduling engine stores the modified assignment in the scheduling repository 150 (step 940).

The resource planner then determines whether the service order end date has changed (step 945). When the service order end date has been changed, the resource planner notifies the customer for whom the service is to be performed (step 950).

The resource planner notifies the service technician or technicians affected by the assignment change (step 955). This may be accomplished, for example, by sending an electronic mail message to the service technician or technicians. This also may be accomplished, when a service technician uses a mobile device, by a synchronization of the scheduling repository of the scheduling server with the scheduling information on the mobile device. In some implementations, the resource planner may notify a service technician by sending a page to a mobile phone of the service technician. The page may prompt the service technician to synchronize the mobile device with the scheduling repository of the scheduling server.

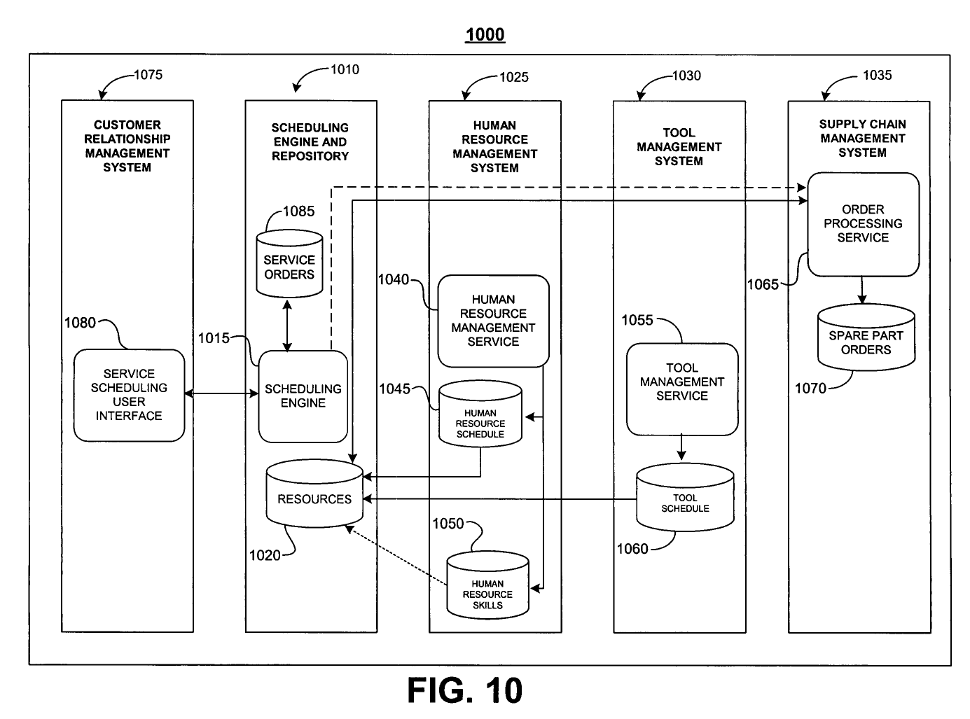

Referring now to FIG. 10, one problem in scheduling a service is the diversity of business processes and software applications that create schedules and manage resources in an enterprise. This can result in conflicts and inconsistencies between assignments made in different systems. The use of a scheduling system that is capable of handling a different types of resource information may help reduce the number of inconsistencies and conflicts that result in scheduling using multiple scheduling systems.

In one implementation, the scheduling engine receives information from external systems and stores the received information in the scheduling repository. Scheduling then is performed using data that resides in scheduling repository. Examples of external systems that may provide information to the scheduling repository include a equipment management system that includes records about tools, a human resource management system, a spare parts inventory management system, and a supply chain management system that identifies when a spare part is scheduled to be received. Also, information may be received from a customer system. This may be particularly useful when a resource, such as a technician employed by the customer or a spare part, is to be provided by the customer.

The scheduling engine and repository 1010, which may be an implementation of the service scheduling server 110 in FIG. 1, includes a scheduling engine 1015 and a resources data store 1020. The scheduling engine and repository 1010 may include information obtained from a human resource management system 1025, a tool management system 1030, and a supply chain management system 1035. More specifically, a human resource management service 1040 of the human resource management system 1025 provides human resource schedule information 1045 to the resources data store 1020 of the scheduling repository. In some implementations, human resource skill information 1050 may be provided by the human resource management service 1055 to the resources data store 1020.

Similarly, a tool management service 1055 of a tool management system 1030 may provide tool information and tool availability information 1060 to the resources data store 1020. An order processing service 1070 of the supply chain management system 1035 may provide spare part order information 1070 to the resources data store 1020. Through these external system interfaces, resource information and scheduling information is provided to the scheduling engine from a single data source, the resources data store 1020.

A service scheduling user interface 1080 is provided by the customer relationship management (CRM) system 1010. The user interface 1080 may include, for example, a planning user interface 700 and a monitoring user interface 800 that includes a work list 810. A service order is created by a user through the use of the service scheduling user interface 1080 and stored in a service order data store 1085 in the scheduling engine and repository 1010. The service order may be created, for example, using the service order entry and scheduling process 200 of FIG. 2. A user is able to monitor the execution of the service order using the service scheduling user interface 1080 of the CRM system. This may be accomplished, for example, as described in FIGS. 4 and 8.

Additionally or alternatively, the availability of spare parts required by a service order may be checked by accessing the order processing service 1070 of the supplier order processing system 1065. This may be particularly useful when a significant delay occurs from the time that a spare part is ordered in the supply chain management system 1035 to the time that the spare part order information is provided to the scheduling engine and repository 1010.

Having a CRM system provide a service scheduling user interface that uses a scheduling engine and repository may be useful. For example, the CRM system may provide an interface with mobile clients, such as laptop computers and personal digital assistants. Such a mobile interface may increase the accuracy of scheduling information in the scheduling repository. For example, a technician may be able to provide task or service order information more easily using a mobile client than using a desktop client which may enable the receipt of more timely or more accurate information as compared with conventional scheduling systems that do not include mobile client integration.

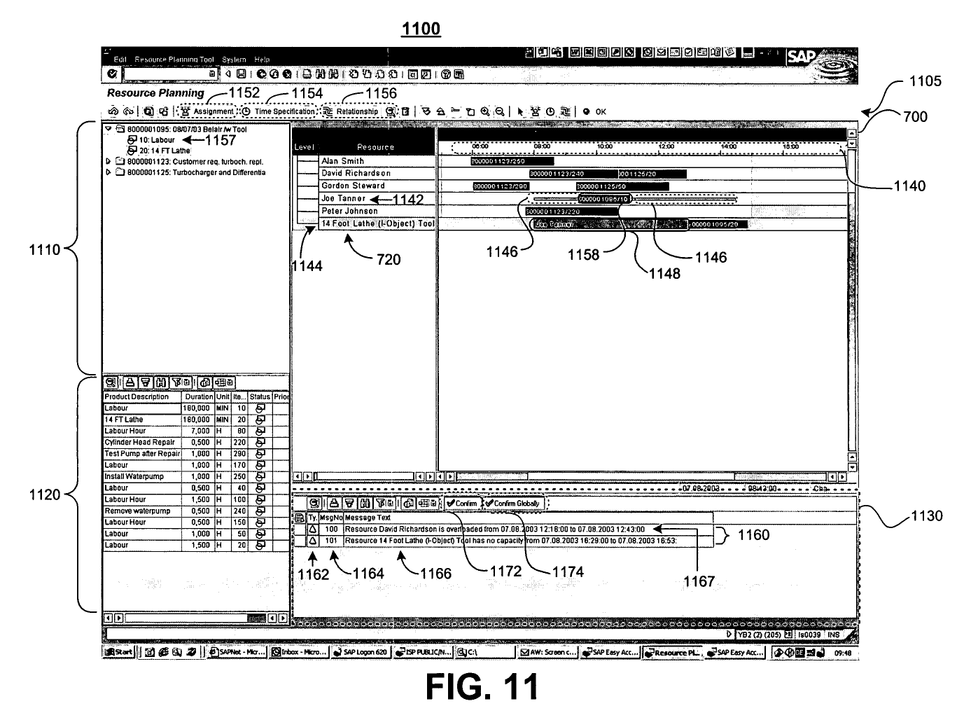

FIG. 11 is another example of a scheduling user interface 1100 that is displayed to a user who is scheduling resources or otherwise planning the execution of work for service orders. The information displayed on the scheduling user interface 1100 is filtered for a particular user based on the business entity or component of a business entity for which the user is responsible for scheduling. For example, a service order may include activities that are to be performed by two different business entities, such as a customer organization and a service component of a service provider. A user who is associated with a particular service component of the service provider only is able to view information related to activities for which the service component is responsible and resources for which the user is responsible for scheduling. The user is unable to view information related to activities for which the customer organization is responsible. The scheduling user interface 1100 includes a planning board 700 and associated controls 1105, a hierarchical work list 1110, a hot list 1120, and an alert monitor 1130.

The planning board 700 includes a chart 710 and resources 720 for which the user is responsible. As described previously in FIG. 7, different types of resources are presented in the planning board 700. In contrast to the date range 740 in the FIG. 7, the planning board 700 includes a time range 1140. The use of a time range rather than a date range may be useful, for example, when an assignment of a resource to a demand generally lasts less than a day. The planning board 700 includes a temporary connection between a human resource 1142 (here, identified as “Joe Tanner”) and a tool resource 1144 (here, identified as a “14 Foot Lathe). The temporary connection is shown as a broken line 1146 in the chart 710 area for the human resource 1142 and as a bar 1148 in the chart 710 area for the tool 1144. The bar 1148 identifies the human resource (here, “Joe Tanner”) to which the tool is assigned.

The scheduling user interface 1100 includes controls 1105 that are associated with the planning board. The controls include an assignment control 1152, a time specification control 1154, and a relationship control 1156.

The assignment control 1152 allows a user to create an assignment of a service order item and a particular resource for a particular time period. For example, the user may use a pointing device to select the assignment control 1152. Then the user is able to use the pointing device to select a particular service order item (such as service order item 1157) and a particular resource (such as human resource 1142 that is identified as “Joe Tanner”) for a particular time to create an assignment. As indicated by assignment 1158 the service item 1157 (identified as “8000001095/10”) is assigned to human resource 1142 (identified as “Joe Tanner”) for the time period of approximately 9 a.m. to 11 a.m. on the particular day shown in the chart 710.

The time specification control 1154 allows a user to identify a time period when a resource is unavailable for a reason other than an assignment. For example, a human resource may be unavailable to be assigned to a service order item because the human resource is on vacation, ill and unable to work, being trained or otherwise unavailable to be scheduled for a particular period of time. Similarly, a tool may be unavailable to be scheduled for use because the tool is scheduled for periodic maintenance.

The relationship control 1156 allows a user to create a temporary connection between a tool and a human resource for a period of time. Unlike an assignment, the relationship between a tool and a human resource is not associated with a service order item. The ability to associate a tool with a human resource independent of an assignment may be useful. For example, a field technician may be assigned a tool for a particular service order item and may carry the tool in the field technician's vehicle throughout the work period, not only for the duration of the assignment to the service order item for which the tool was required. In another example, a tool may be associated with a field technician for a period of time or may be permanently associated with a particular human resource.

The work list 1110, like the work list 810 in FIG. 8, is a hierarchical view of service order items for which the scheduler is responsible. In contrast with the work list 1110, the hot list 1120, like the hot list 820 in FIG. 8, is a non-hierarchical list capable of displaying different views of open service order items for which the scheduler is responsible. In one example of a host list 1120, a user may select to display all service order items for a particular customer (regardless of whether the service order items are for different service orders for the particular customer). In another example, a user may select to display all service order items with a high priority or high urgency. The hot list 1120 also allows a user to identify the types of information (such as, a field in a record, a column in a database table, or an attribute in an XML file) to be displayed for the service order items in the hot list.

The scheduling user interface 1100 includes an alert monitor 1130, like the alert monitor 830 in FIG. 8, that displays a list of alerts 1160. Each alert in the list 1160 includes an alert type 1162, a message number 1164 that identifies a particular message, and an alert description 1166. The alert type 1162 identifies a category to which the alert message is associated. The alerts in the list 1160 identify constraints that are associated with the information displayed in the scheduling user interface 1100 but are not necessarily associated with a particular service order. For example, alert 1167 indicates that a particular human resource is overscheduled for a period of time. When the alert, such as alert 1167, in the alert list 1160 is selected (such as by double-clicking on the message text 1166 of a particular alert with a pointing device), the assignments that are related to the selected alert are highlighted.

The alert monitor 1130 is dynamic such that the alerts in the alert list 1160 reflect the current planning situation on the planning board. As assignments are changed, a particular alert may be created or resolved (and, hence, disappear from the alert list 1160 in the alert monitor 1130). In some implementations, the scheduling user interface 1100 may allow a user to schedule service order items, see the alerts that occur with new scheduling choices (including assignments, time specification and relationships), and modify scheduling choices in response to alerts. When the scheduler is satisfied with the schedule, the scheduler then may save the schedule to persistent storage. The ability to allow the scheduler to modify the schedule without committing the schedule to persistent storage may be useful. For example, the scheduling user interface may include an undo feature to eliminate an unwanted scheduling choice made by a user prior to committing the schedule to persistent storage. Similarly, the scheduling user interface may include a redo feature to repeat a wanted scheduling choice that previously had been eliminated.

The alert monitor 1130 also includes a confirm control 1172 and a confirm globally control 1174. The confirm control 1172 allows a user to eliminate a selected alert such that the alert is not displayed in the scheduling user interface 1100 for the particular user. The confirm globally control 1174 allows a user to eliminate a selected alert such that the alert is not displayed in a scheduling user interface 1100 for any user. Some implementations may be able to restrict access to the confirm globally control 1174 to particular users.

In some implementations, a scheduling user interface 1100 may be used without filtering the displayed information for a user. This may be particularly useful when a user of the scheduling system is not associated with a service component (such as a service team or service group) or are otherwise responsible for scheduling all of the service orders.

Any of the planning board 700, the work list 1110, the hot list 1120 and the alert monitor 1130 of the scheduling user interface 1100 may be a pane of a graphical user interface in which the pane is displayed in a fixed position on a display device. In some implementations, one or more of the planning board 700, the work list 1110, the hot list 1120 and the alert monitor 1130 of the scheduling user interface 1100 may be a window for which a user may control the display position on a display device. A user's control over the display position of a window may include, for example, indirect or direct control of the coordinates of the display device at which the window is positioned, the size of the window, and the shape of the window.

A number of implementations of the invention have been described. Nevertheless, it will be understood that various modifications may be made without departing from the spirit and scope of the invention. Accordingly, other implementations are within the scope of the following claims.

What is claimed is:

1. A computer system for scheduling resources needed to perform service actions, the system comprising:
an engine that associates, based on user input, resource information with task items that need to be completed as part of performing a service action; and
a repository of resource information associable with the task items, the repository including human resource information, reusable resource information, and non-reusable resource information, wherein:
the human resource information includes availability information for human resources,
the reusable resource information includes availability information for reusable resources, and
the non-reusable resource information includes availability information for non-reusable resources.

2. The system of claim 1 wherein:
the repository includes non-resource constraint information, and
the engine associates, based on user input and non-resource constraint information, resource information with task items.

3. The system of claim 2 wherein the non-resource constraint information is provided to the repository of resource information from a computer system other than the computer system for scheduling resources.

4. The system of claim 2 wherein the non-resource constraint information comprises information about contractual requirements.

5. The system of claim 1 wherein the availability information for human resources comprises availability information for individuals.

6. The system of claim 1 wherein the availability information for human resources comprises availability information for groups of individuals.

7. The system of claim 1 wherein the availability information for reusable resources comprises availability information for tools.

8. The system of claim 1 wherein the availability information for reusable resources comprises availability information for work areas.

9. The system of claim 1 wherein the availability information for non-reusable resources comprises availability information for spare parts.

10. The system of claim 1 wherein:
the task items include a human resource skill requirement,
the human resource information includes a indication of a skill possessed by particular human resources that are represented in the human resource information, and
the engine associates a particular human resource with a particular task item only when the indication of the skill possessed by the particular human resource matches the human resource skill requirement of the task item.

11. The system of claim 1 wherein:
the task items include a tool characteristic,
the reusable resource information includes an indication of a tool characteristic for particular tools that are represented in the reusable resource information, and
the engine associates a particular tool with a particular task item only when the indication of the tool characteristic for a particular tool matches the tool characteristic of the task item.

12. The system of claim 1 wherein the availability information for human resources is provided to the repository of resource information from a computer system other than the computer system for scheduling resources.

13. The system of claim 1 wherein the availability information for reusable resources is provided to the repository of resource information from a computer system other than the computer system for scheduling resources.

14. The system of claim 1 wherein the availability information for non-reusable resources is provided to the repository of resource information from a computer system other than the computer system for scheduling resources.

15. The system of claim 1 wherein the engine and the repository of resource information are capable of communicating using a network with mobile clients.

16. The system of claim 15 wherein the engine is configured to send, to each mobile client, resource information associated with task items that need to be completed as part of performing a particular service action.

17. The system of claim 15 wherein the engine is configured to receive, from each mobile client, user input for the purpose of associating resource information with a particular task item.

18. A data repository comprising resource information associated with task items that need to be completed as part of performing a service action, the repository including human resource information and reusable resource information, wherein:
the human resource information includes availability information for human resources, and
the reusable resource information includes availability information for reusable resources.

19. The data repository of claim 18 wherein:
the repository further comprises non-reusable resource information, and
the non-reusable resource information includes availability information for non-reusable resources.

20. The data repository of claim 19 wherein the repository further comprises non-resource constraint information capable of being associated with task items.

21. A computer-implemented method for scheduling resources needed to perform service actions, the method comprising:
associating, based on user input, resource information with task items that need to be completed as part of performing a service action; and
storing resource information associated with the task items, the resource information including human resource information, reusable resource information, and non-reusable resource information, wherein:
the human resource information includes availability information for human resources,
the reusable resource information includes availability information for reusable resources, and
the non-reusable resource information includes availability information for non-reusable resources.

22. The method of claim 21 further comprising:
storing non-resource constraint information, and
associating, based on user input and non-resource constraint information, resource information with task items.

23. The method of claim 22 wherein the non-resource constraint information is provided from a computer system other than a computer system used for scheduling resources.

24. The method of claim 22 wherein the non-resource constraint information comprises information about contractual requirements.

25. A computer-readable medium or propagated signal having embodied thereon a computer program configured to schedule the performance of service actions, the medium or signal comprising one or more code segments configured to:
associate, based on user input, resource information with task items that need to be completed as part of performing a service action; and
store resource information associated with the task items, the resource information including human resource information, reusable resource information, and non-reusable resource information, wherein:
the human resource information includes availability information for human resources,
the reusable resource information includes availability information for reusable resources, and
the non-reusable resource information includes availability information for non-reusable resources.

26. The medium or signal of claim 25 wherein the one or more code segments are further configured to:
store non-resource constraint information, and
associate, based on user input and non-resource constraint information, resource information with task items.

27. The medium or signal of claim 26 wherein the non-resource constraint information is provided from a computer system other than a computer system used for scheduling resources.

28. The medium or signal of claim 26 wherein the non-resource constraint information comprises information about contractual requirements.
